(19) United States
(12) Patent Application Publication
(10) Pub. No.: US 2024/0045064 A1
(43) Pub. Date: Feb. 8, 2024

(54) METHODS AND SYSTEMS FOR DATA MAPPING USING ROADSIDE LiDAR SENSOR DATA AND GEOGRAPHIC INFORMATION SYSTEM (GIS) BASED SOFTWARE

(71) Applicant: BOARD OF REGENTS OF THE NEVADA SYSTEM OF HIGHER EDUCATION, ON BEHALF OF THE UNIVERSITY OF NEVADA, Reno, NV (US)

(72) Inventor: Hao Xu, Reno, NV (US)

(21) Appl. No.: 17/879,858

(22) Filed: Aug. 3, 2022

(51) Int. Cl. G01S 17/89; G08G 1/07

(52) U.S. Cl. CPC G01S 17/89; G08G 1/07

(57) ABSTRACT

An improved data mapping method for roadside LiDAR sensor data which is accurate, inexpensive to implement and that provides data which is easy to use and/or interpret. In an embodiment a computer processor running Geographic Information System (GIS)-based software obtains geographic coordinates data for a roadway section with objects within a detection range of a roadside LiDAR sensor system. Next, the computer processor receives roadside LiDAR sensor data expressed as LiDAR cartesian coordinates data for the roadway section, receives selection by a user of a plurality of reference objects defined by the geographic coordinates data and by the LiDAR cartesian coordinates data, calculates transition matrixes for transforming the LiDAR cartesian coordinates data into geographic coordinates data, and converts the LiDAR cartesian coordinates data into LiDAR geographic coordinates data using the transition matrixes. In some implementations, the computer processor transmits the LiDAR geographic coordinate data to a user computer for analysis, and/or displays the LiDAR geographic coordinate data of the roadway section on a display screen.

### BACKGROUND

Light Detection and Ranging (LiDAR) is a remote sensing technology that emits laser light to illuminate and detect objects and map their distance measurements. Specifically, a LiDAR device targets an object with a laser and then electronically measures the time for the reflected light to return to a receiver. LiDAR has been utilized for many different types of applications such as making digital 3-D representations of areas on the earth's surface and ocean bottom.

LiDAR sensors have been used in the intelligent transportation field because of their powerful detection and localization capabilities. For example, LiDAR sensors have been installed on autonomous vehicles (or self-driving vehicles) and used in conjunction with other sensors, such as digital video cameras and radar devices, to enable the autonomous vehicle to safely navigate along roads.

It has recently been recognized that LiDAR sensor systems could potentially be deployed as part of the roadside infrastructure, for example, incorporated into a traffic light system at intersections or otherwise positioned at roadside locations as a detection and data generating apparatus. An advantage of LiDAR sensor systems is that they can be used to collect three-dimensional traffic data without being affected by light conditions, and the detected traffic data can then be used by connected vehicles (CVs) and by other infrastructure systems to aid in preventing collisions and to protect non-motorized road users (such as pedestrians). The traffic data may also be used to evaluate the performance of autonomous vehicles, and for the general purpose of collecting traffic data for analysis. For example, roadside LiDAR sensor data at a traffic light can be used to identify when and where vehicle speeding is occurring, and it can provide a time-space diagram which shows how vehicles slow down, stop, speed up and go through the intersection during a light cycle. In addition, roadside LiDAR sensor data can be utilized to identify “near-crashes,” where vehicles come close to hitting one another (or close to colliding with a pedestrian or a bicyclist), and thus identify intersections or stretches of roads that are potentially dangerous.

A common misconception is that the application of a roadside LiDAR sensor system is similar to the application of an on-board vehicle LiDAR sensor, and that therefore the same processing procedures and/or algorithms utilized by on-board LiDAR systems could be applicable to roadside LiDAR sensor systems (possibly with minor modifications). However, on-board LiDAR sensors mainly focus on the surroundings of the vehicle and the goal is to directly extract objects of interest from a constantly changing background. In contrast, roadside LiDAR sensors must detect and track all road users in a traffic scene against a static background. Thus, infrastructure-based, or roadside LiDAR sensing systems have the capability to provide behavior-level multimodal trajectory data of all traffic users, such as presence, location, speed, and direction data of all road users gleaned from raw roadside LiDAR sensor data. In addition, low-cost sensors may be used to gather such real-time, all-traffic trajectories for extended distances, which can provide critical information for connected and autonomous vehicles so that an autonomous vehicle traveling into the area covered by a roadside LiDAR sensor system becomes aware of potential upcoming collision risks and the movement status of other road users while the vehicles are still at a distance away from the area or zone. Thus, the tasks of obtaining and processing trajectory data are different for a roadside LiDAR sensor system than for an on-board vehicle LiDAR sensor system.

Accordingly, for infrastructure-based or roadside LiDAR sensor systems, it is important to detect target objects in the environment quickly and efficiently because fast detection speeds provide the time needed to determine a post-detected response, for example, by an autonomous vehicle to avoid a collision with other road users in the real-world. Detection accuracy is also a critical factor to ensure the reliability of a roadside LiDAR based sensor system. Thus, roadside LiDAR sensor systems are required to exclude the static background points and finely partition those foreground points as different entities (clusters).

Intelligent Transportation Systems (ITS) is an advanced application that can offer innovative services relating to different modes of transportation and enable road users to be better informed and make safer, more coordinated, and ‘smarter’ use of transport networks. To obtain accurate traffic data to serve the ITS, many different types of sensors have been used such as cameras, loop detectors, radar, Bluetooth sensors and the like. All these sensors can provide the basic and necessary data for ITS, but there are some limitations on these data as traditional sensors installed on the road or roadside only provide traffic flow rates, spot speed, average speeds, and occupancy, and such macro traffic data cannot fully meet the requirements of the ITS. In addition, advanced camera systems that can provide high-resolution micro traffic data (HRMTD) may be adversely affected by light conditions. Thus, LiDAR sensor systems are becoming more popular in transportation field applications.

In addition to supporting connected and autonomous vehicles, the all-traffic trajectory data generated by a roadside LiDAR system may be valuable for traffic study and performance evaluation, advanced traffic operations, and the like. For example, analysis of lane-based vehicle volume data can achieve an accuracy above 95%, and if there is no infrastructure occlusion, the accuracy of road volume detection can generally be above 98% for roadside LiDAR sensor systems. Other applications for collected trajectory data include providing conflict data resources for near-crash analysis, including collecting near-crash data (especially vehicle-to-pedestrian near-crash incidents) that may occur during low-light level situations such as during rainstorms and/or during the night hours when it is dark. In this regard, roadside LiDAR sensors deployed at fixed locations (e.g., road intersections and along road medians) provide a good way to record trajectories of all road users over the long term, regardless of illumination conditions. Traffic engineers can then study the historical trajectory data provided by the roadside LiDAR sensor system at multiple scales to define and extract near-crash events, identify traffic safety issues, and recommend countermeasures and/or solutions.

As mentioned above, LiDAR sensor systems offer an advantage over traffic cameras and/or video-based infrastructure systems in that accurate and complete LiDAR system sensor data can be generated even under bad or suboptimal lighting conditions that would adversely affect the quality of video recordings. For example, a LiDAR system sensor can generate accurate and complete vehicle data at night and/or under low-light conditions and during other conditions that would adversely affect the quality of the data generated by a video-based roadside infrastructure system. Furthermore, the analysis of infrastructure-based video data requires significantly more processing and computing power than what is needed to process LiDAR system sensor data. Roadside LiDAR systems also have an advantage over other sensing and detection technologies (such as inductive loop, microwave radar, and video camera technologies) in the ability to obtain trajectory-level data and provide improved performance in the accurate detection and tracking of pedestrians and vehicles.

When a roadside LiDAR sensor system generates all-road user trajectory data and other traffic performance measurement data, this data is spatially located within a LiDAR sensor local coordinate system having x-y-z coordinates (cartesian coordinates) with the LiDAR sensor at the center point. However, real-time data users, such as connected and autonomous vehicles, cannot easily use data that is represented by local x-y-z coordinates. In addition, such real-time local data is also difficult for traffic data analysts to interpret. Thus, the inventors recognized that there is a need for an improved data mapping method for roadside LiDAR sensor data which is accurate, inexpensive to implement and that provides data which is easy to use and/or interpret.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and example embodiments and which are not necessarily drawn to scale, wherein:

FIG. 1A depicts a LiDAR sensor system installation located at an intersection of roadways in accordance with some embodiments of the disclosure;

FIG. 1B illustrates another embodiment of a roadside LiDAR sensor system situated alongside a road, or alongside a road segment, in accordance with embodiments of the disclosure;

FIG. 1C illustrates a portable roadside LiDAR sensor system located along a road segment in accordance with some embodiments of the disclosure;

FIG. 1D illustrates another embodiment of a portable roadside LiDAR sensor system which may be located along a road segment in accordance with some embodiments of the disclosure;

FIG. 2 is a functional diagram illustrating the components of a portable roadside LiDAR sensor system in accordance with some embodiments of the disclosure;

FIG. 3 is a functional diagram illustrating the components of a permanent roadside LiDAR sensor system embodiment in accordance with the disclosure;

FIG. 4 is a top perspective view of an intersection within detection range of a roadside LiDAR sensor system (not shown) illustrating multiple reference points that have been selected using GIS software in accordance with the disclosure.

FIG. 5 illustrates an example of reference point data collection in the LiDAR point cloud in accordance with some embodiments of the disclosure.

FIG. 6 illustrates a third coordinate system called an Earth-Centered, Earth-Fixed (ECEF) coordinate system which can be used to match the same reference point in the cartesian coordinate system and the World Geodetic System (WGS) coordinates system.

FIG. 7 is a table listing the transformation methods used in geodesy to produce distortion-free transformations from one datum to another.

FIG. 8 is an overhead diagram of a Blue Parking Lot illustrating the distribution of two hundred and thirty-three (233) data points collected by a GPS device within one hundred meters (100 m) of a roadside LiDAR sensor in accordance with the disclosure.

FIG. 9 depicts the boundaries of each of twelve zones concerning the 233 points shown in FIG. 8.

FIG. 10 is a plot of a regression line of the average offsets for eight groups of reference points in accordance with some embodiments.

FIG. 11 illustrates the average offsets for eight different scenarios based on the distribution of reference points shown in FIGS. 8 and 9.

FIG. 12 is a flowchart of a process for mapping roadside LiDAR sensor data in a format useful for analysis in accordance with some embodiments of the disclosure.

FIG. 13 is a block diagram of a roadside LiDAR data processing computer in accordance with some embodiments of the disclosure.

### DETAILED DESCRIPTION

Reference will now be made in detail to various novel embodiments, examples of which are illustrated in the accompanying drawings. The drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of the embodiments may be practiced without some or all of the specific details. In other instances, well-known process operations have not been described in detail in order not to unnecessarily obscure novel aspects. In addition, terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used.

In general, and for the purposes of introducing concepts of embodiments of the present disclosure, presented is an improved data mapping method for traffic data analysts and real-time road data users involving the use of roadside LiDAR sensor data and the use of geographic information system (GIS)-based software. Specifically, in some embodiments GIS-based software and a roadside LiDAR sensor system data are both used to collect reference points. Examples of GIS-based software include Google Maps™, Bing Maps™ Google Earth™, and ArcGIS™, and in embodiments disclosed herein, data obtained from Google Earth™ software is utilized. It has been found that Google Earth™ software provides high precision longitude and latitude information for generating a base map without a user having to pay any additional fees. In addition, the operability of the Google Earth™ software has been found to be better and/or easier to use than Google Map™ or Bing Map™. However, these and other types of GIS-based software could be utilized. As explained herein, the improved data mapping process includes three main steps: reference points matching, transformation matrix calculations, and LiDAR data mapping. In an example process disclosed herein, the number and the distribution of the reference points are analyzed and then the best number of reference points and their distribution are identified, which data then can be used as recommendations for users for mapping a roadside LiDAR point cloud.

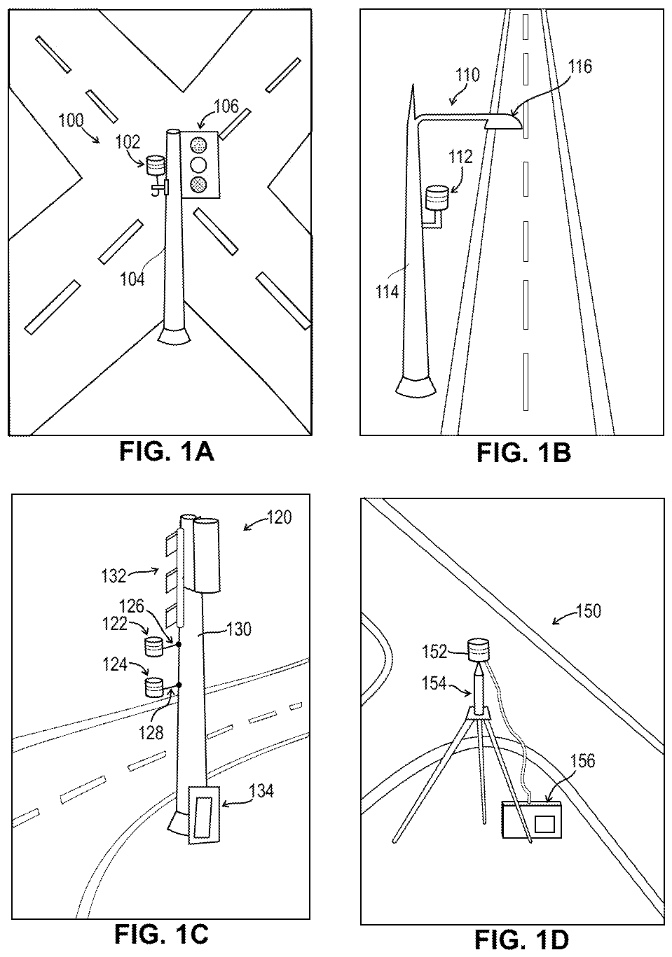

FIGS. 1A to 1D depict several different types of roadside LiDAR sensor system deployments in accordance with some embodiments. LiDAR sensors use a wide array of infra-red lasers paired with infra-red detectors to measure distances to objects, and there are several companies that manufacture LiDAR sensor products, such as the Velodyne® Company of San Jose, Calif. The LiDAR sensors are usually securely mounted within a compact, weather-resistant housing and include an array of laser/detector pairs that spin rapidly within the fixed housing to scan the surrounding environment and provide a rich set of three-dimensional (3D) point data in real time. The lasers themselves are commonly used in other applications, for example in barcode scanners in grocery stores and for light shows and are eye-safe (will not damage human eyes). The selection of a particular type of LiDAR sensor to utilize depends on the purpose or application, and thus factors that may be considered include the number of channels (resolution of LiDAR scanning), the vertical field of view (FOV), and the vertical resolution of laser beams. A LiDAR sensor may have anywhere from eight (8) to one-hundred and twenty-eight (128) laser beams that are rotated 360 degrees to measure the surrounding environment in real-time. In general, LiDAR sensors with more laser channels, larger vertical FOV, and higher resolution are more productive in data collection.

FIG. 1A is an example of a permanent LiDAR sensor system installation 100 located at an intersection of roadways. As shown, the LiDAR sensor 102 is affixed to a traffic light pole 104 that includes a traffic light 106. In some implementations, raw sensor data generated by the roadside LiDAR sensor 102 may be transmitted via a wired or wireless connection (not shown), for example, to an edge computer (not shown) and/or to a datacenter that includes one or more server computers (not shown) for processing.

FIG. 1B illustrates another embodiment of a roadside LiDAR sensor system 110 situated alongside a road, or alongside a road segment, in accordance with the disclosure. The LiDAR sensor 112 is attached to a lamppost 114 that includes a streetlamp 116. Like the LiDAR sensor system 100 of FIG. 1A, in some embodiments the sensor data generated by the roadside LiDAR sensor 112 may be transmitted via a wired or wireless connection (not shown), for example, to an edge computer (not shown) and/or to a datacenter that includes one or more server computers (not shown) for processing.

FIG. 1C illustrates a portable roadside LiDAR sensor system 120 located along a road segment in accordance with some embodiments. In this implementation, a first LiDAR sensor 122 and a second LiDAR sensor 124 may be removably affixed via connecting arms 126 and 128, respectively, to a traffic light post 130 below a traffic light 132 (or traffic signal head) as shown so as to be reachable for portable system installation and removal. The LiDAR sensor system 120 includes a portable sensor data processing unit 134 containing electronic circuitry (not shown) which may process the data generated by both the roadside LiDAR sensors 122 and 124 on-site and/or may transmit the sensor data and/or the processed data to a datacenter that includes one or more server computers (not shown), which may utilize the sensor data for further processing. The roadside LiDAR sensors assembly (sensors 122, 124 along with the connecting arms 126, 128 and data processing unit 134) may be left in place to gather traffic related data for days, weeks or months.

FIG. 1D illustrates another embodiment of a portable roadside LiDAR sensor system 150 which may be located along a road segment in accordance with some embodiments. In this implementation, a first LiDAR sensor 152 is supported by a tripod 154 that is placed alongside a road or, for example, in a road median (not shown). The LiDAR sensor system 150 may also include a portable sensor data processing unit 156 which may store and/or process sensor data generated by the roadside LiDAR sensor 152. In some implementations, the LiDAR sensor system 150 is a standalone unit which is left on-site for only short periods of time, such as for a few hours, and then transported to a datacenter or otherwise operably connected to a host computer for processing and/or analyzing the traffic data captured by the roadside LiDAR sensor 152.

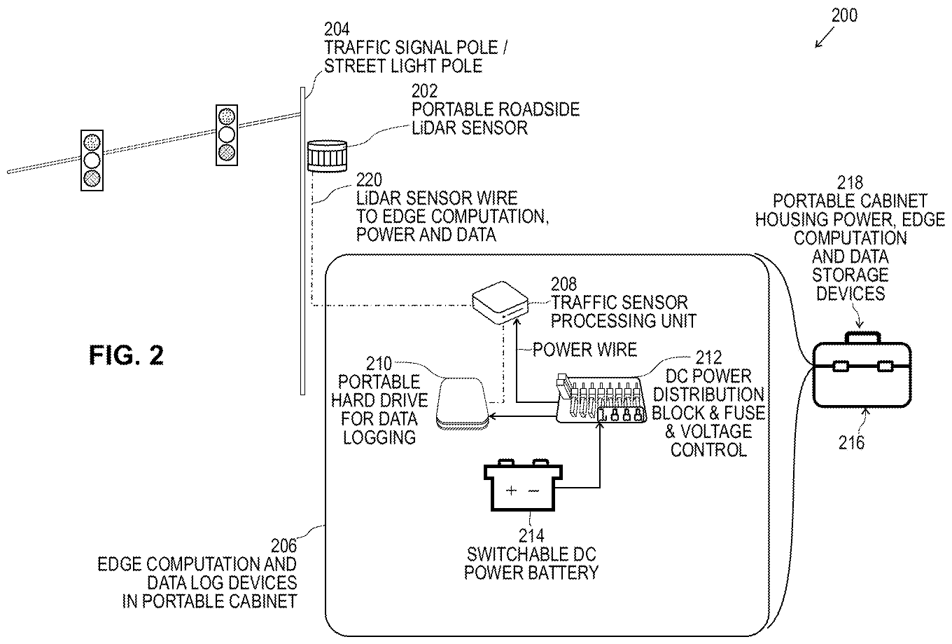

FIG. 2 is a functional diagram 200 illustrating the components of a portable roadside LiDAR sensor system in accordance with some embodiments. A portable roadside LiDAR sensor 202 is affixed to a traffic signal pole 204 (which may also be a streetlight pole). Edge processing circuitry 206 may include a traffic sensor processing unit 208 (or traffic sensor CPU), a portable hard drive 210, power control circuitry 212 and a battery 214 all housed within a hard-shell case 216 having a handle 218. The traffic sensor processing unit or CPU 208 may be a computer or several computers or a plurality of server computers that work together as part of a system to facilitate processing of roadside LiDAR sensor data. In such a system, different portions of the overall processing of such roadside LiDAR sensor data may be provided by one or more computers in communication with one or more other computers such that an appropriate scaling up of computer availability may be provided if and/or when there is a need for greater workloads, for example if a large amount of roadside traffic data is generated and requires processing.

Referring again to FIG. 2, a wired or wireless connection 220 may electronically connect the roadside LiDAR sensor 202 to the edge processing circuitry. In some implementations, the traffic sensor processing unit 208 receives raw traffic data from the roadside LiDAR sensor 202, processes it and stores the processed data in the portable hard drive 210. The power control circuitry 212 is operably connected to the battery 214 and provides power to both the traffic sensor processing unit 208 and the portable hard drive 210. In some implementations, the edge processing circuitry 206 may be physically disconnected from the roadside LiDAR sensor 202 so that the hard-shell case 216 can be transported to a datacenter (not shown) or otherwise operably connected to a host or server computer (not shown) for processing and/or analyzing the traffic data captured by the roadside LiDAR sensor 202.

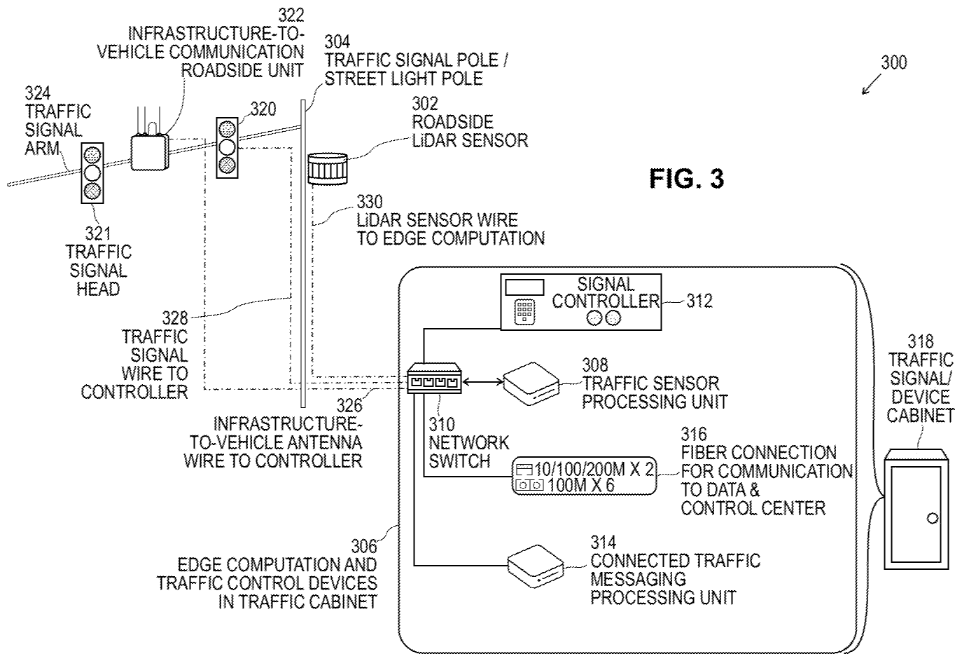

FIG. 3 is a functional diagram 300 illustrating the components of a permanent roadside LiDAR sensor system in accordance with some embodiments. A roadside LiDAR sensor 302 is affixed to a traffic signal pole 304 (which may also be a streetlight pole) and is operably connected to edge processing circuitry 306 which may be housed within a roadside traffic signal device cabinet 318. In some embodiments the roadside traffic signal device cabinet 318 is locked and hardened to safeguard the electronic components housed therein against vandalism and/or theft.

Referring again to FIG. 3, in some embodiments the edge processing circuitry 306 includes a network switch 310 that is operably connected to a traffic sensor processing unit 308 (or traffic sensor CPU), to a signal controller 312, to a connected traffic messaging processing unit 314, and to a fiber-optic connector 316 (and in some embodiments to a fiber-optic cable, not shown). In some implementations, in addition to being operably connected to the roadside LiDAR sensor 302, the network switch 310 is also operably connected to the traffic light 320 and to a transmitter 322, which transmitter is operable to function as an infrastructure-to-vehicle roadside communication device. In the illustrated embodiment, the traffic lights 320 and 321, and the transmitter 322, are affixed to a traffic signal arm 324 that is typically positioned so that these devices are arranged over a roadway, typically over an intersection of roadways. In some implementations, the transmitter 322, the traffic light 320, and the roadside LiDAR sensor 302 are electrically connected to the network switch 310 via wires or cables 326, 328 and 330, respectively. In other implementations, these devices may instead be wirelessly connected to the network switch 310. In some embodiments, the traffic sensor processing unit 308 receives raw traffic data from the roadside LiDAR sensor 302, processes it and operates with the connected traffic messaging processing unit 314 and transmitter 322 to transmit data and/or instructions to a connected vehicle (CV) which may be traveling on the road and approaching the intersection. In addition, the traffic sensor processing unit 308 may transmit data via the fiberoptic connector 316 to a remote data and control center (not shown) for further processing and/or analysis.

The roadside LiDAR sensing systems described above with reference to FIGS. 1A through 1D, FIG. 2 and FIG. 3 may provide behavior-level, multimodal trajectory data of all traffic users, including but not limited to cars, buses, trucks, motorcycles, bicycles, wheelchair users, pedestrians, and wildlife. Such real-time, all-traffic trajectories data can be gathered for extended distances and this critical information may be transmitted, in some implementations to real-time to connected and/or autonomous vehicles. Such operation permits autonomous vehicles traveling into the area covered by such a roadside LiDAR sensor system to be aware of potential upcoming collision risks and to be aware of the movement status of other road users while still being at a distance away from the area.

Embodiments disclosed herein include data collection and preparation steps, wherein the geographic coordinates for reference objects are first collected using GIS-based software, such as Google Earth™ software.

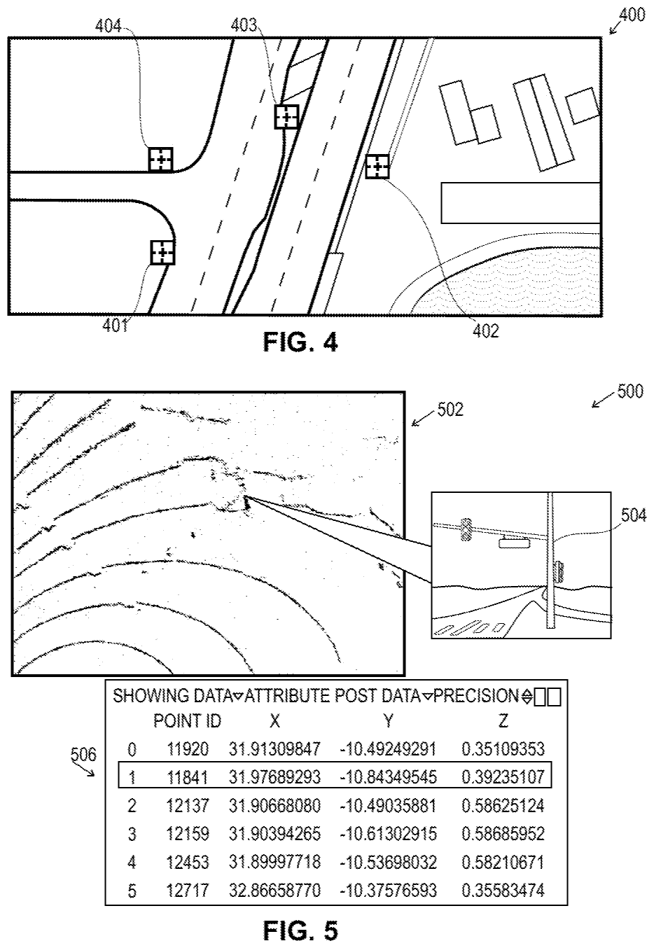

FIG. 4 is an overhead view or top perspective view 400 of a roadway section generated by Google Earth™ software that includes features and/or objects within a detection range of a roadside LiDAR sensor system (not shown). It has been found that large measurement errors can occur when a user utilizes Google Earth™ software to manually select reference points, and thus to minimize such measurement errors users are instructed to select roadside objects or reference objects having fixed locations and/or to select obvious roadside features having fixed locations as the reference points. For example, referring again to FIG. 4 some reference points that may be selected include a traffic sign 401 on the side of a road segment, a utility pole 402 which may be installed on the road segment and/or at an intersection, the location of the start of a median 403 that separates northbound and southbound traffic, and a boulder 404 marking the location of the start of an access road. Other examples of fixed-location roadside objects that may be selected can include, but are not limited to, a corner of a building, a fire hydrant, a light pole, a traffic light and the like. In embodiments disclosed herein, any such selected reference points are within a detection range of a LiDAR sensor system (not shown in FIG. 4).

In an example embodiment, a VLP-32C LiDAR sensor system (manufactured by the Velodyne Company as the “LiDAR Ultra Puck”) generates data for use in mapping reference points within a LiDAR point cloud. The VLP-32C sensor system uses thirty-two (32) laser beams paired with detectors to scan the surrounding environment, and the detection range of the LiDAR sensor is up to two-hundred meters (200 m) with a 360-degree horizontal field of view (FoV) and a 40-degree vertical field of view. The Velodyne VLP-32 LiDAR sensor system returns readings of objects in spherical coordinates, wherein a point is defined by a distance (D) and two angles (azimuth and polar angle).

In some implementations, the data generated by the Velodyne VLP-32 LiDAR sensor system during use may be processed by using “VeloView™” software to generate a LiDAR data point cloud and display the point cloud on a display screen of, for example, a laptop computer or desktop computer. Thus, in some embodiments the VeloView™ software may be utilized to generate data representing roadside features or objects that correspond to the reference points selected by a user using GIS-based software, for example, by using Google Earth™ software.

FIG. 5 is a diagram 500 illustrating an example of a LiDAR point cloud 502 generated by using data from a roadside LiDAR sensor system in accordance with embodiments disclosed herein. In particular, in disclosed implementations reference point data can be collected from the LiDAR point cloud 502 that match the reference objects which were selected using GIS-based software and that are represented by geographic coordinates. Thus, by using processes disclosed herein a roadside traffic pole 504 which was selected as a reference point using the GIS-based software having geographic coordinates can be matched to the same reference point in the LiDAR point cloud 502 having cartesian coordinates 506 (x, y and z). In some cases, a selected reference object may have multiple corresponding LiDAR data points in the LiDAR point cloud 502 but only one is needed.

In an implementation, reference points are measured in two coordinate systems: the cartesian coordinate system and the World Geodetic System (WGS) 1984 coordinates system. The WGS 1984 is the latest version and it is a standard for use in cartography, geodesy, and satellite navigation including global positioning systems (GPS).

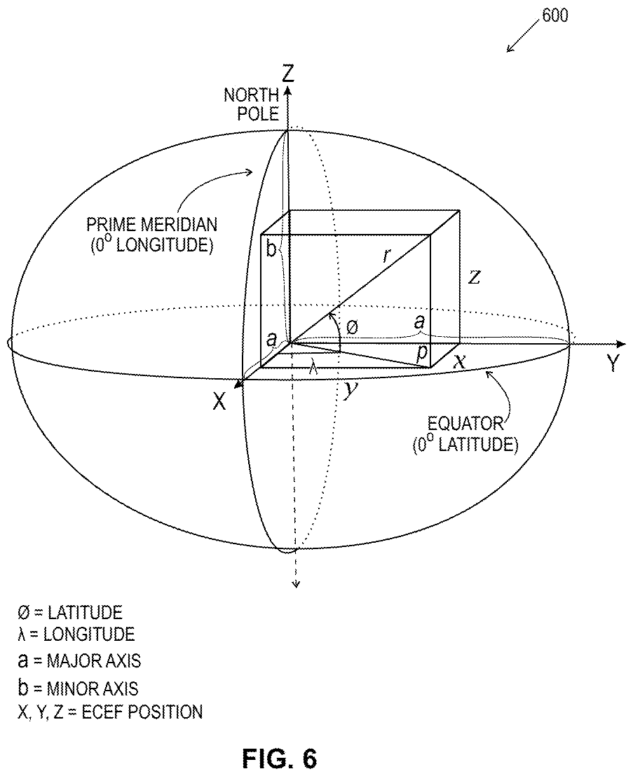

FIG. 6 illustrates a third coordinate system called an Earth-Centered, Earth-Fixed (ECEF) coordinate system 600, which is needed to convert a reference point location expression between the LiDAR sensor's cartesian coordinate system and the WGS 1984 coordinate system. In other words, the ECEF coordinate system is used to match the same reference point in the cartesian coordinate system with that of a reference point in the WGS 1984 coordinates system. The data in the ECEF coordinate system is another way of representing the position of a point on the earth, and the diagram shown in FIG. 6 illustrates the relationship between the ECEF coordinate system and the WGS 1984 coordinate system. Reference point coordinates in the WGS 1984 coordinate system can be directly converted to the ECEF coordinate system using the equations shown in (1) below:

$$\begin{matrix}X = ( N + H ) \times cos ϕ \times cos λ \\ Y = ( N + H ) \times cos ϕ \times sin λ \\ Z = [ N \times ( 1 - {e}^{2} ) + H ] \times sin ϕ\end{matrix} \} \qquad ( 1 )$$

In the above equation, N is the Curvature radius of the ellipsoidal ring; e is the first eccentricity of the ellipsoid; X is the x-coordinate value of the reference point in the ECEF coordinate system; Y is the y-coordinate value of the reference point in the ECEF coordinate system; Z is the z-coordinate value of the reference point in the ECEF coordinate system; ϕ is the latitude of the reference point; λ is the longitude of the reference point; and H is the elevation of the reference point.

The influence of elevation on the results is discussed below for two different methods for collecting reference points. The curvature radius of the ellipsoidal ring N can be calculated based on Equation (2), below:

$$N = \frac{a}{W} \qquad ( 2 )$$

Wherein a represents the long radius of the ellipsoid, which is 6378137 m, and W represents the first auxiliary coefficient. W can be obtained from equation (3) below.

W=\sqrt{(1−e²×sin² ϕ)} (3)

Where e represents the first eccentricity of the ellipsoid and ϕ presents the latitude of the point, wherein e=0.00332 and sin² ϕ ∈[0,1], the thresholds of W are [0.999994,1]. The values of the W and N can be rounded to:

$$W = \sqrt{1 - {e}^{2} * {sin}^{2} ϕ} = 1$$

$$N = \frac{a}{W} = a = 6378137 m$$

$$1 - {e}^{2} = 1$$

Accordingly, equation (1) can now be simplified to:

$$\begin{matrix}X = ( N + H ) \times cos ϕ \times cos λ \\ Y = ( N + H ) \times cos ϕ \times sin λ \\ Z = ( N + H ) \times sin ϕ\end{matrix} \} \qquad ( 4 )$$

It should be noted that the elevations (H) in any city in the United States are much smaller than the Curvature radius of the ellipsoidal ring, so elevation values have little effect on the calculation results of Equation 4. Assuming an elevation measurement error σ m, related ECEF coordinate errors can be calculated by using Equation (5).

$${δ}_{X} = {δ}_{Y} = {δ}_{Z} = \frac{σ}{N + H} ∈ [ \begin{matrix}1.5676 \times {10}^{- 7} \times σ , & 1.5678 \times {10}^{- 7} \times σ ]\end{matrix} \qquad ( 5 )$$

When σ=1000 m, which means there is a 1000 m elevation measurement offset, there is a relative error of 1.5 cm for the outputs, which can be ignored. Based on the analysis, the tolerance for the elevation (H) measurement of reference points is high.

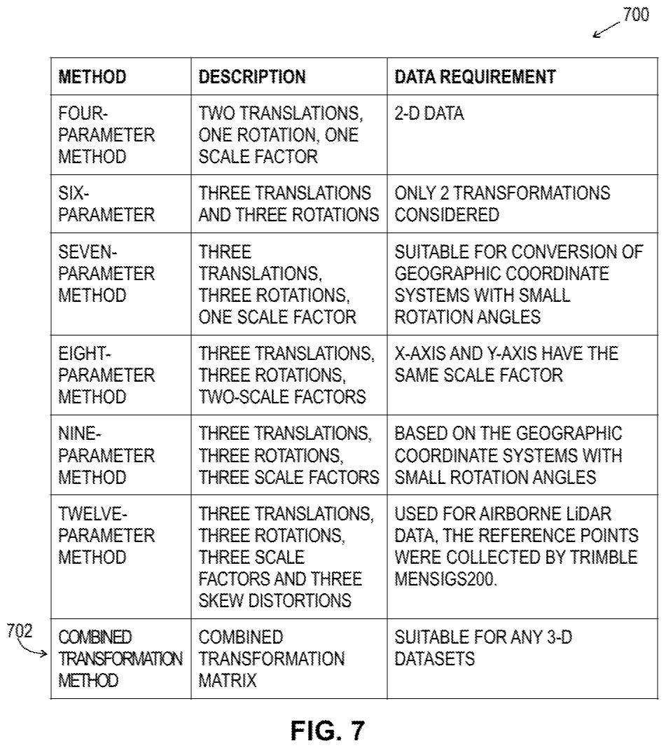

FIG. 7 is a table 700 listing the transformation methods used in geodesy to produce distortion-free transformations from one datum to another. In accordance with processes disclosed herein, the combined transformation method (row 702) is utilized. Thus, to transform the data in the LiDAR Cartesian coordinate system to the ECEF coordinate system, the reference points are expressed in homogeneous coordinates. The value of the reference point in the LiDAR Cartesian coordinate system is expressed as: [xᵢ yᵢ zᵢ 1]. The value of the same reference point in the ECEF coordinate system is expressed as: [Xᵢ Yᵢ Zᵢ, 1]. A combined transformation matrix T is needed to transform the data in the LiDAR Cartesian coordinate system into the ECEF coordinate system, which is based on Equation (7).

[Xᵢ Yᵢ Zᵢ 1]=[xᵢ yᵢ zᵢ 1]*T (6)

There are four main transformation steps that make up the combined transformation matrix T: scaling, rotation, shear mapping, and translation. T is a square matrix of order four (4) and can be expressed as shown below:

$$T = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ]$$

According to the calculation rules of the matrix, the solution of the transformation matrix T can be obtained from Equation (7), which is shown below. Due to the order of T, at least four reference points are needed based on the equation.

$$T = {[ \begin{matrix}{x}_{1} & {y}_{1} & {z}_{1} & 1 \\ {x}_{2} & {y}_{2} & {z}_{2} & 1 \\ {x}_{3} & {y}_{3} & {z}_{3} & 1 \\ {x}_{4} & {y}_{4} & {z}_{4} & 1\end{matrix} ]}^{- 1} \times [ \begin{matrix}{X}_{1} & {Y}_{1} & {Z}_{1} & 1 \\ {X}_{2} & {Y}_{2} & {Z}_{2} & 1 \\ {X}_{3} & {Y}_{3} & {Z}_{3} & 1 \\ {X}_{4} & {Y}_{4} & {Z}_{4} & 1\end{matrix} ] \qquad ( 7 )$$

When the number of the reference points is greater than four, the Least-squares methods is applied to solve the overdetermined problem. Least-squares is an optimization mathematical technique to optimize the function fitting a dataset, which can be expressed as shown in equation (8) below.

$$\hat{T} = {( {A}^{T} A )}^{- 1} {A}^{T} B \qquad ( 8 )$$

$$Where , A = [ \begin{matrix}{x}_{1} & {y}_{1} & {z}_{1} & 1 \\ {x}_{2} & {y}_{2} & {z}_{2} & 1 \\ ⋮ & ⋮ & ⋮ & ⋮ \\ {x}_{m} & {y}_{m} & {z}_{m} & 1\end{matrix} ] \cdot T is the transformation matrix .$$

$$B = [ \begin{matrix}{X}_{1} & {Y}_{1} & {Z}_{1} & 1 \\ {X}_{2} & {Y}_{2} & {Z}_{2} & 1 \\ ⋮ & ⋮ & ⋮ & ⋮ \\ {X}_{m} & {Y}_{m} & {Z}_{m} & 1\end{matrix} ] , and m > 4.$$

According to the characteristics of the earth, the data in the ECEF can be converted into the WGS 1984 coordinate system by using the Equations (9):

$$\begin{matrix}λ = arctan ( \frac{Y}{X} ) \\ ϕ = arctan ( \frac{Z + {e}^{′2} \times b \times {sin}^{3} θ}{\sqrt{{X}^{2} + {Y}^{2}} - {e}^{2} \times a \times {cos}^{3} θ} ) \\ H = \frac{Z}{sin ϕ} - N \times ( 1 - {e}^{2} )\end{matrix} \} \qquad ( 9 )$$

$$Where , θ = arctan ( \frac{a \times Z}{b \times \sqrt{{X}^{2} + {Y}^{2}}} ) .$$

In the above equations, e is the second eccentricity of the ellipsoid; a is the Long radius of the ellipsoid and b is the short radius of the ellipsoid.

For roadside LiDAR sensing systems, Equation 8 and Equation 9 shown above are calculated with selected reference points and applied to either all of the cloud points' LiDAR cartesian coordinates, or in some implementations are applied to the LiDAR cartesian coordinates associated with trajectory data. In both cases the x, y, and z values from the LiDAR sensor system are utilized to obtain the corresponding points in WGS 1984 geography coordinates. Thus, the cloud points can then be used for GIS data analysis, and the trajectories data can be used to serve connected vehicles and intelligent transportation systems in real-time.

Next, a sensitivity analysis was undertaken wherein the number and distribution of reference points are analyzed to determine the mapping accuracy of the disclosed methods.

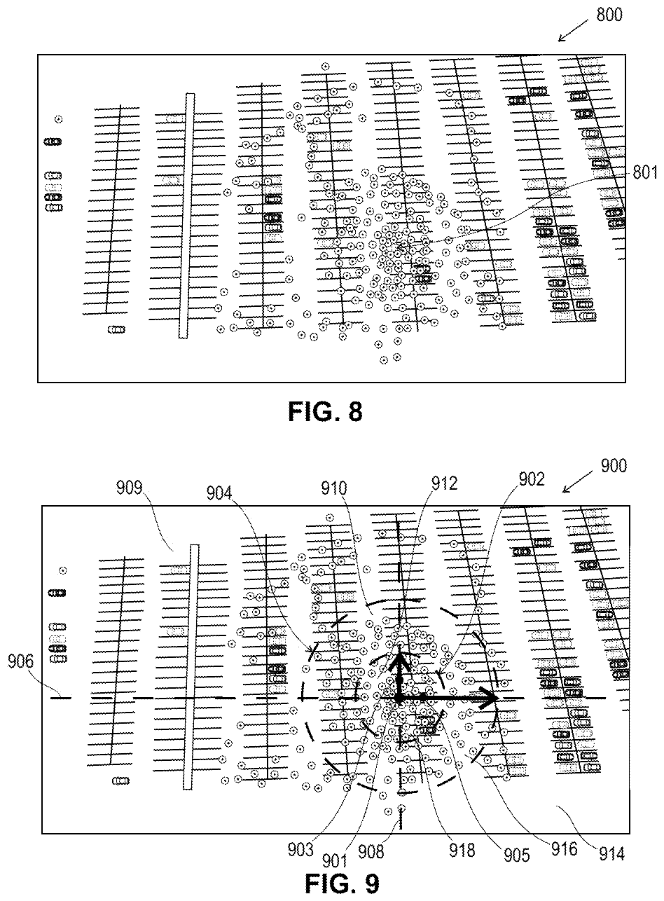

FIG. 8 is top view of a “Blue Parking Lot” 800 illustrating two hundred and thirty-three (233) data points which were collected by a Trimble R2 GPS device within one hundred meters (100 m) of a roadside LiDAR sensor located at 801. Based on the location of the roadside LiDAR sensor 801, the distribution of the GPS points was divided into twelve (12) zones which are shown in FIG. 9. In particular, FIG. 9 depicts twelve boundaries or zones 900 into which the 233 data points shown in FIG. 8 are grouped. An inner circle 902 has a radius 903 of 12.5 m from the center point 901, which center point 901 is the location of the LiDAR sensor system, and an outer circle 904 has a radius 905 of 25 m from the center point 901.

As shown in FIG. 9, two perpendicular straight lines 906 and 908 intersect at the center point 901 of the circular sections and divide the entire detection area into twelve parts, wherein each part represents one zone containing multiple data points. Based on the direction and distance, a name for each zone can be assigned as shown in Table 1 below. For example, the left-most upper section 909 outside of the circle is named “Far Northwest” while the left-most upper section of the outer circle 910 is named “Middle Northwest” and the and the left-most upper section of the inner circle 912 is named “Near Northwest.” Likewise, the right-most lower section 914 outside of the circle is named “Far Southeast” while the right-most lower section of the outer circle 916 is named “Middle Southeast” and the and the right-most lower section of the inner circle 918 is named “Near Southeast.”

TABLE 1
Distance and direction for each zone

| Boundary | Distance | Direction | | | |
|---|---|---|---|---|---|
| Inside the inner circle | Near | Northeast | Northwest | Southeast | Southwest |
| Between the two circles | Middle | Northeast | Northwest | Southeast | Southwest |
| Outside of the outer circle | Far | Northeast | Northwest | Southeast | Southwest |

The influence of different distributions and numbers of the reference points on mapping accuracy may be analyzed in accordance with these points. In an implementation, some of the measured GPS points were used as reference points and others were used to verify the accuracy of the reference points obtained according to the processes disclosed herein, by calculating the offset between measured GPS locations and the calculated GPS locations. In particular, the offset between the measured GPS point A (LatA, LonA) and the calculated GPS point B (LatB, LonB) can be calculated based on the Great Circle Distance Equation (10) shown below.

ΔD=R×arccos(sin(LatA)×sin(LatB)+cos(LatA)×cos(LatB)×cos(LonA−LonB)) (10)

Where, R is the average radius of the earth which equals 6,371,004 m, and ΔD is the offset between two points(m).

In an embodiment, four to eight GPS points were randomly selected and used as reference points, and unselected points were used as validation points.

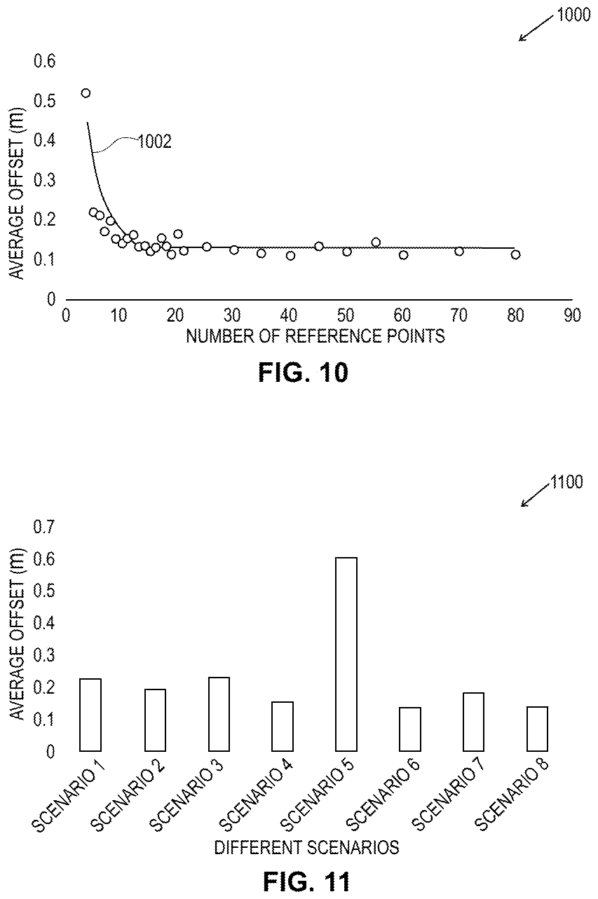

FIG. 10 illustrates the average offsets for each group wherein the dots are the average offsets for each number of reference points, and the line 1002 is a regression line which can be expressed as:

$$y = \{ \begin{matrix}9 / 5 x & 4 \leq x \leq 13 \\ 0.138 & 13 \leq x\end{matrix} \qquad ( 5 )$$

Where, y is the average offset and x is the number of reference points.

Based on the regression function, when the number of the reference points is greater than or equal to 13, the offset between the measured GPS locations and the calculated GPS locations is minimal (it equals 0.138 m).

The distribution of the reference points is shown in FIGS. 8 and 9, and based on the distribution, there are eight different scenarios:
Scenario 1: all the reference points were selected from the same zones near the sensor.
Scenario 2: the reference points were selected from different zones near the sensor.
Scenario 3: all the reference points were selected from the same zones in the middle.
Scenario 4: the reference points were selected from different zones in the middle.
Scenario 5: all the reference points were selected from the same zones far from the sensor.
Scenario 6: the reference points were selected from different zones far from the senor.
Scenario 7: the reference points were selected from different zones in the same direction.
Scenario 8: the reference points were selected from different zones in different directions.

In an example, ten groups of data were analyzed for each scenario listed above, and in each group, 13 reference points were selected. FIG. 11 illustrates the average offsets 1100 for each of the scenarios defined above. Concerning reference points chosen from the same zone, the average offset of scenario 1 equals that of scenario 3 and is smaller than the average offset of scenario 5, which means that when the reference point's available collection area is in the same direction the location within 25 m from the sensor should be chosen as the suitable place. By comparing the average offsets of scenarios 1 and 2, scenarios 3 and 4, and scenarios 5 and 6, it is shown that the scattered reference points have less errors than clustered reference points. For scattered reference points, the farther away from the LiDAR sensor, the smaller the error.

Thus, when selecting reference points, the suggested reference point locations are those located around the roadside LiDAR sensor rather than along the same direction of the sensor. For example, if all of the reference points are located east of the LiDAR sensor, then the calculated WGS 1984 coordinates will include higher errors or more offsets from the actual coordinates. Thus, for best results the reference points should be distributed around the LiDAR sensor in various directions rather than to one side. In addition, the distances of the reference points in relation to the LiDAR sensor should be different and should be more than twenty-five meters (25 m) away.

In summary, after reference points are selected using GIS-related software and generated by the LiDAR sensor, three main steps are performed: reference points matching, transformation matrix calculation, and data mapping. As explained above, in an example following the data mapping step, a sensitivity analysis was used to determine the best number and distribution for the collection of reference points. Data was thus collected in the physical world and then used to verify the proposed method, and the results showed a 0.138 m offset between measured GPS location points and the calculated location points. In addition, another data mapping method was selected for comparison, and based on that result the average offset for one frame of data was calculated as being 2.21 m (wherein the total number of LiDAR points is 37,832) so the method disclosed herein is superior.

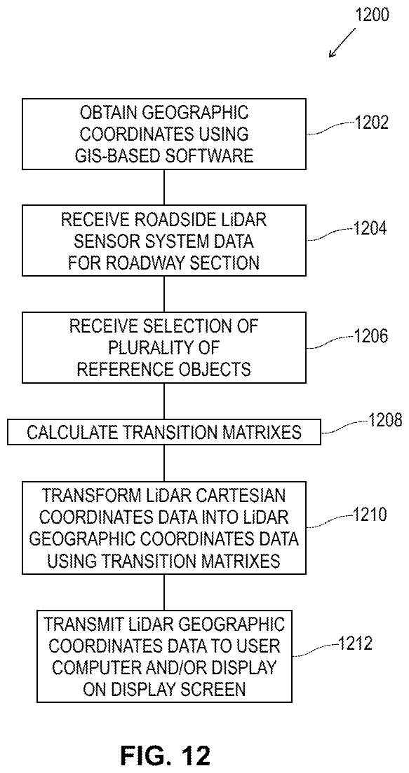

FIG. 12 is a flowchart 1200 illustrating a method for mapping roadside LiDAR sensor data in a format useful for analysis in accordance with some embodiments. A computer processor obtains 1202, by using Geographic Information System (GIS)-based software, geographic coordinates data for a roadway section that includes objects within a detection range of a roadside LiDAR sensor system. Next, the computer processor receives 1204 roadside LiDAR sensor data expressed as LiDAR cartesian coordinates data from the roadside

LiDAR sensor system for the roadway section, and receives 1206 via an input device, selection by a user of a plurality of reference objects defined by the geographic coordinates data and by the LiDAR cartesian coordinates data. The computer processor then calculates 1208 transition matrixes for transforming the LiDAR cartesian coordinates data into geographic coordinates data, and next transforms 1210 the LiDAR cartesian coordinates data into LiDAR geographic coordinates data using the transition matrixes. In some embodiments, the computer processor then transmits 1212 the LiDAR geographic coordinate data to a user computer for analysis and/or displays the LiDAR geographic coordinate data of the roadway section on a display screen for analysis by a user.

In some embodiments of the method 1200 for mapping roadside LiDAR sensor data, the step of converting the LiDAR cartesian coordinates data into LiDAR geographic coordinates data may include the computer processor utilizing the transition matrixes to first convert the LiDAR cartesian coordinate data into LiDAR Earth-Centered, Earth-Fixed (ECEF) coordinate data, and then to convert the LiDAR ECEF coordinate data into geographic coordinate data. In addition, the geographic coordinates data may WGS 1984 coordinates data, the roadside LiDAR sensor data may be trajectory data, and the selected reference objects may include roadside features having fixed locations, such as at least one of a traffic sign, a utility pole, a corner of a building, a fire hydrant, a light pole, a traffic light pole, a start of a median, and a boulder. The GIS-based software used in the process may be Google Earth™ software, and the the detection range of the LiDAR sensor system may be up to two hundred meters (200 m) with a three hundred and sixty-degree (360°) horizontal field of view (FoV) and a forty-degree (40°) vertical field of view.

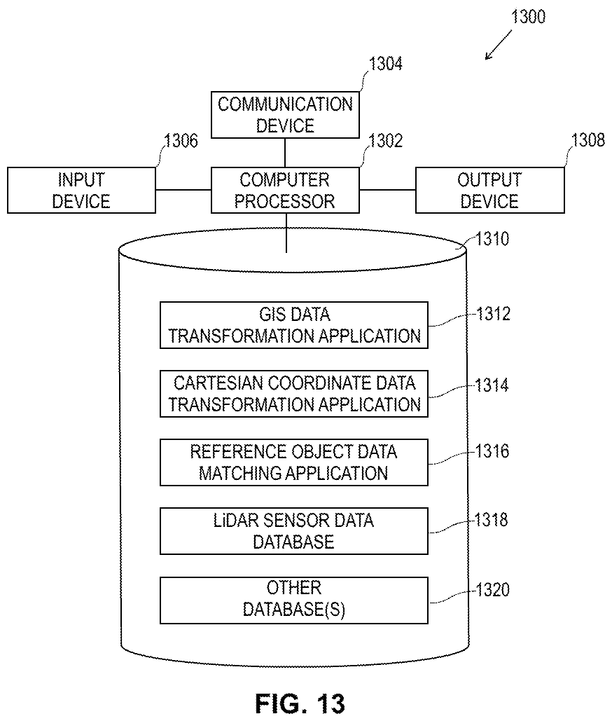

FIG. 13 is a block diagram of a roadside LiDAR data processing computer 1300 according to an embodiment. The roadside LiDAR data processing computer 1300 may be controlled by software to cause it to operate in accordance with aspects of the methods presented herein concerning processing traffic data generated by one or more roadside LiDAR sensors. In particular, the roadside LiDAR data processing computer 1300 may include a roadside LiDAR processor 1302 operatively coupled to a communication device 1304, an input device 1306, an output device 1308, and a storage device 1310. However, it should be understood that, in some embodiments the roadside LiDAR data processing computer 1300 may include several computers or a plurality of server computers that work together as part of a system to facilitate processing of roadside LiDAR data generated by a roadside LiDAR sensor or roadside LiDAR sensor system. In such a system, different portions of the overall method for facilitating processing of raw LiDAR sensor data may be provided by one or more computers in communication with one or more other computers such that an appropriate scaling up of computer availability may be provided if and/or when greater workloads, for example a large amount of raw traffic data from one or more LiDAR sensors, is encountered.

The roadside LiDAR data computer 1300 may constitute one or more processors, which may be special-purpose processor(s), that operate to execute processor-executable steps contained in non-transitory program instructions described herein, such that the traffic data processing computer 1000 provides desired functionality.

Communication device 1304 may be used to facilitate communication with, for example, electronic devices such as roadside LiDAR sensors, traffic lights, transmitters and/or remote server computers and the like devices. The communication device 1304 may, for example, have capabilities for engaging in data communication (such as traffic data communications) over the Internet, over different types of computer-to-computer data networks, and/or may have wireless communications capability. Any such data communication may be in digital form and/or in analog form.

Input device 1306 may comprise one or more of any type of peripheral device typically used to input data into a computer. For example, the input device 1306 may include a keyboard, a computer mouse and/or a touchpad or touchscreen. Output device 1308 may comprise, for example, a display screen (which may be a touchscreen) and/or a printer and the like.

Storage device 1310 may include any appropriate information storage device, storage component, and/or non-transitory computer-readable medium, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage” or a “storage medium.”

The term “computer-readable medium” as used herein refers to any non-transitory storage medium that participates in providing data (for example, computer executable instructions or processor executable instructions) that may be read by a computer, a processor, an electronic controller and/or a like device. Such a medium may take many forms, including but not limited to, non-volatile media and volatile media. Non-volatile media may include, for example, optical or magnetic disks and other persistent memory. Volatile media may include dynamic random-access memory (DRAM). Common forms of computer-readable media include, for example, a floppy disk, a flexible disk, hard disk, magnetic tape, a solid state drive (SSD), any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in providing sequences of computer processor-executable instructions to a processor. For example, sequences of instruction (i) may be delivered from RAM to a processor, (ii) may be wirelessly transmitted, and/or (iii) may be formatted according to numerous formats, standards or protocols, such as Transmission Control Protocol, Internet Protocol (TCP/IP), Wi-Fi, Bluetooth, TDMA, CDMA, and 3G.

Referring again to FIG. 13, storage device 1310 stores one or more programs for controlling the processor 1302. The programs comprise program instructions that contain processor-executable process steps of the roadside LiDAR data processing computer 1300, including, in some cases, process steps that constitute processes or methods provided in accordance with principles of the processes disclosed herein. In some embodiments, such programs may include a GIS data transformation application 1312, a cartesian coordinate data transformation application 1314, a reference object data matching application 1316.

The storage device 1310 may also include one or more roadside Lidar sensor data database(s) 1318 which may store, for example, traffic trajectory data and the like, and which may also include computer executable instructions for controlling the roadside LiDAR data computer 1300 to process raw LiDAR sensor data and/or information for tracking vehicles and the like. The storage device 1310 may also include one or more other database(s) 1320 and/or have connectivity to other databases (not shown) which may be required for operating the traffic data processing computer 1300.

Application programs and/or computer readable instructions run by the roadside LiDAR data processing computer 1300, as described above, may be combined in some embodiments, as convenient, into one, two or more application programs. Moreover, the storage device 1310 may store other programs or applications, such as one or more operating systems, device drivers, database management software, web hosting software, and the like.

Accordingly, the processes disclosed herein solves the technical problem of how to provide an improved data mapping method for roadside LiDAR sensor data that is accurate and inexpensive to implement, and that provides location data (i.e., traffic data) that can easily be used by traffic data analysts and real-time data users. These goals are achieved by having a computer processor convert roadside LiDAR sensor system data for a road segment from LiDAR cartesian coordinates data to geographic coordinates data (WGS 1984) for real-time applications or for further data analysis. As explained herein, in order to convert the LiDAR cartesian coordinate data to data in the WGS 1984 format, the LiDAR cartesian coordinate data must first be converted to Earth-Centered, Earth-Fixed (ECEF) coordinate system data, and then from the ECEF coordinate system data to WGS 1984 format data. Thus, embodiments disclosed herein complete the coordinate conversions by utilizing transition matrixes, which are calculated by utilizing the reference points' WGS 1984 coordinates and cartesian coordinates.

As used herein, the term “computer” should be understood to encompass a single computer or two or more computers in communication with each other.

As used herein, the term “processor” should be understood to encompass a single processor or two or more processors in communication with each other.

As used herein, the term “memory” should be understood to encompass a single memory or storage device or two or more memories or storage devices.

As used herein, a “server” includes a computer device or system that responds to numerous requests for service from other devices.

As used herein, the term “module” refers broadly to software, hardware, or firmware (or any combination thereof) components. Modules are typically functional components that can generate useful data or other output using specified input(s). A module may or may not be self-contained. An application program (sometimes called an “application” or an “app” or “App”) may include one or more modules, or a module can include one or more application programs.

The above descriptions and illustrations of processes herein should not be considered to imply a fixed order for performing the process steps. Rather, the process steps may be performed in any order that is practicable, including simultaneous performance of at least some steps and/or omission of steps.

Although the present disclosure has been described in connection with specific example embodiments, it should be understood that various changes, substitutions, and alterations apparent to those skilled in the art can be made to the disclosed embodiments without departing from the spirit and scope of the disclosure.

What is claimed is:

1. A method for mapping roadside LiDAR sensor data comprising:
obtaining, by a computer processor running Geographic Information System (GIS)-based software, geographic coordinates data for a roadway section comprising objects within a detection range of a roadside LiDAR sensor system;
receiving, by the computer processor from the roadside LiDAR sensor system, roadside LiDAR sensor data expressed as LiDAR cartesian coordinates data for the roadway section;
receiving, by the computer processor from an input device, selection by a user of a plurality of reference objects defined by the geographic coordinates data and by the LiDAR cartesian coordinates data;
calculating, by the computer processor, transition matrixes for transforming the LiDAR cartesian coordinates data into geographic coordinates data; and
converting, by the computer processor using the transition matrixes, the LiDAR cartesian coordinates data into LiDAR geographic coordinates data.

2. The method of claim 1 further comprising at least one of:
transmitting, by the computer processor, the LiDAR geographic coordinate data to a user computer for analysis; and
displaying, by the computer processor on a display screen, the LiDAR geographic coordinate data of the roadway section.

3. The method of claim 1 wherein converting the LiDAR cartesian coordinates data into LiDAR geographic coordinates data comprises utilizing, by the computer processor, the transition matrixes to first convert the LiDAR cartesian coordinate data into LiDAR Earth-Centered, Earth-Fixed (ECEF) coordinate data, and then to convert the LiDAR ECEF coordinate data into geographic coordinate data.

4. The method of claim 1, wherein the geographic coordinates data is WGS 1984 coordinates data.

5. The method of claim 1, wherein the roadside LiDAR sensor data is trajectory data.

6. The method of claim 1, wherein the plurality of reference objects comprise roadside features having fixed locations.

7. The method of claim 6, wherein the roadside features comprise at least one of a traffic sign, a utility pole, a corner of a building, a fire hydrant, a light pole, a traffic light pole, a start of a median, and a boulder.

8. The method of claim 1, wherein the GIS-based software comprises Google Earth™ software.

9. The method of claim 1, wherein the detection range of the LiDAR sensor system is up to two hundred meters (200 m) with a three hundred and sixty-degree (360°) horizontal field of view (FoV) and a forty-degree (40°) vertical field of view.

10. A LiDAR sensor data processing computer comprising:
a computer processor;
a communication device operably connected to the computer processor; and
a storage device operably connected to the computer processor, wherein the storage device stores processor executable instructions which when executed cause the computer processor to:
run Geographic Information System (GIS)-based software to obtain geographic coordinates data for a roadway section comprising objects within a detection range of a roadside LiDAR sensor system;
receive roadside LiDAR sensor data expressed as LiDAR cartesian coordinates data for the roadway section from the roadside LiDAR sensor system;
receive selection, by a user utilizing an input device, of a plurality of reference objects defined by the geographic coordinates data and by the LiDAR cartesian coordinates data;
calculate transition matrixes for transforming the LiDAR cartesian coordinates data into geographic coordinates data; and
convert, using the transition matrixes, the LiDAR cartesian coordinates data into LiDAR geographic coordinates data.

11. The LiDAR sensor data processing computer of claim 10, wherein the storage device stores further processor executable instructions which when executed cause the computer processor to at least one of:
transmit the LiDAR geographic coordinate data to a user computer for analysis; and
display the LiDAR geographic coordinate data of the roadway section on a display screen.

12. The LiDAR sensor data processing computer of claim 10, wherein the instructions for using the transition matrixes to convert the LiDAR cartesian coordinate data into LiDAR geographic coordinates data comprises further instructions, which when executed cause the computer processor to use the transition matrixes to first convert the LiDAR cartesian coordinate data into LiDAR Earth-Centered, Earth-Fixed (ECEF) coordinate data, and then to convert the LiDAR ECEF coordinate data into geographic coordinate data.

13. The LiDAR sensor data processing computer of claim 10, wherein the geographic coordinates data is WGS 1984 coordinates data.

14. The LiDAR sensor data processing computer of claim 10, wherein the roadside LiDAR sensor data is trajectory data.

15. The LiDAR sensor data processing computer of claim 10, wherein the plurality of reference objects comprise roadside features having fixed locations.

16. The LiDAR sensor data processing computer of claim 15, wherein the roadside features comprise at least one of a traffic sign, a utility pole, a corner of a building, a fire hydrant, a light pole, a traffic light pole, a start of a median, and a boulder.

17. The LiDAR sensor data processing computer of claim 10, wherein the GIS-based software comprises Google Earth™ software.

18. The LiDAR sensor data processing computer of claim 10, wherein the detection range of the LiDAR sensor system is up to two hundred meters (200 m) with a three hundred and sixty-degree (360°) horizontal field of view (FoV) and a forty-degree (40°) vertical field of view.
